(19) United States
(12) Patent Application Publication
(10) Pub. No.: US 2009/0248882 A1
(43) Pub. Date: Oct. 1, 2009

(54) Virtual social group management system, virtual social group management method, and computer program

(75) Inventors: Tomohiro Takagi, Kagawa (JP); Hitoshi Kamura, Kagawa (JP)

Correspondence Address: STAAS & HALSEY LLP, SUITE 700, 1201 NEW YORK AVENUE, N.W., WASHINGTON, DC, 20005, US

(73) Assignee: FUJITSU SHIKOKU SYSTEMS LIMITED, Kagawa (JP)

(21) Appl. No.: 12/314,087

(22) Filed: Dec. 3, 2008

(30) Foreign Application Priority Data
Mar. 28, 2008 (JP) JP2008-088761

(51) Int. Cl. G06F 15/16

(52) U.S. Cl. 709/229

(57) ABSTRACT

An SNS system is provided with: a user attribute storage unit that stores user attributes for each user; a community attribute storage unit that stores a community grade rank for each community; an access allowance/rejection determination unit that determines whether or not to allow a user to access a community based on the community grade rank of the community and the user attributes of the user; and a community viewing processing unit that executes a process for distributing the content uploaded in the community to the user in the case where the access allowance/rejection determination unit has determined to allow the user to access the social group, and does not execute the process for distributing the content uploaded in the community to the user in the case where the access allowance/rejection determination unit has determined to prohibit the user from accessing the social group.

### BACKGROUND OF THE INVENTION

1. Field of the Invention

The embodiments discussed herein are directed to a system, method, and the like for managing a virtual social group such as an online community.

2. Description of the Related Art

It has recently become both cheap and easy to connect a personal computer to a network such as the Internet. Furthermore, mobile telephone terminals have seen both improvements in functionality and advancements in applications, and it has become easy to connect to the Internet using mobile telephone terminals as well.

As a result, many users are becoming able to communicate with one another via a network such as the Internet. While the electronic bulletin board is well-known as a communication service, SNSs (Social Networking Services) have also become known as communication services. SNSs include services known as “communities”.

Usually, individual specific themes are specified for these electronic bulletin boards and communities. Users can discover electronic bulletin boards or communities that they have an interest in, and post articles thereon, view articles posted by other users, and so on. Accordingly, using electronic bulletin boards and communities enables the formation of virtual social groups in which many users living in different regions congregate.

These services have a benefit that users can freely participate and freely exchange opinions with one another. However, the high degree of freedom also leads to inconvenience and anxiety for users. Accordingly, the following methods and systems have been proposed.

Conventionally, a community platform system provides entertainment by allowing multiple users to play the part of characters appearing in novels and other fictitious characters, using email, telephony, and so on. This community platform system is provided with a mental health section. The mental health section allows a psychiatrist to indirectly diagnose the psychological states of users through the users' conversations. Such a configuration makes it possible for users to safely communicate with one another.

Conventionally, there is a method in which members register self-introduction information, and members who have been confirmed as having fulfilled participation conditions set by an administrator or who have newly registered a self-introduction and a nickname are allowed to access a bulletin board page. This makes it possible to prevent participants from impersonating one another and to suppress irresponsible statements from being made.

Conventionally, a community creation system creates communities consisting of users unknown to one another. This community creation system consists of multiple terminal apparatuses and a server, where each terminal apparatus stores personal information on the user and information on a partner with whom communication is desired (a partner), identification information and a communication history of the partner, and an intimacy level with respect to the partner; the communication history is updated based on communication with the partner, and the intimacy level is then updated based on the communication history. The server stores the personal information on each user and the information on the partner as well as matching rules (rules) used to match the user to that partner, updates the rules based on the intimacy level received from the terminal apparatus, and selects a matching partner based on the personal information on the user, the information on the partner, and the rules. The server then sends the respective partners' profiles to the terminal apparatuses of the users who have been matched, and sends the identification information on the partners to each other's terminal apparatuses when they have authorized communication. Each user commences communication based on the identification information on the partner.

Conventionally, there is a method for evaluating a virtual community. According to this method, a degree of formality of a virtual community is evaluated by focusing on the relationship of affiliations of members between an actual organization and the virtual community. Furthermore, the status, position, and so on of the virtual community is evaluated using a relative amount of data traffic, rather than using an absolute amount of data traffic.

However, virtual social groups such as electronic bulletin boards and online communities also have the following problems. For instance, with a social group that restricts its participation qualifications to users who fulfill specific requirements, there are situations where users who do not fulfill the specific requirements can access the group and view the content thereof.

### SUMMARY

It is an aspect of the embodiments discussed herein to provide a virtual social group management system including a user attribute storage portion that stores, for each first user, user attributes that are attributes of the first user, a social group evaluation rank storage portion that stores a social group evaluation rank for each virtual social group by which the first users exchange content with one another via a communication line, the social group evaluation rank being a rank of evaluation of the virtual social group, an access allowance/rejection determination portion that determines whether or not to allow the first user to access the virtual social group based on the social group evaluation rank for the virtual social group stored in the social group evaluation rank storage portion and the user attributes of the first user stored in the user attribute storage portion, and a content distribution portion that executes a process for distributing content uploaded in the virtual social group to the first user where the access allowance/rejection determination portion has determined to allow the first user to access the virtual social group, and does not execute the process for distributing the content uploaded in the virtual social group to the first user where the access allowance/rejection determination portion has determined to prohibit the first user from accessing the virtual social group.

The virtual social group management system may include a viewing restriction storage portion that stores, for each social group evaluation rank, a restricted age that is an age for which access to the content uploaded in the virtual social group is restricted. The user attribute storage portion may store, as the user attributes of the first user, a user age that is an age of the first user, the social group evaluation rank storage portion may store, as the social group evaluation rank for the virtual social group, a rank based on a content quality evaluation that is an evaluation of quality of the content uploaded in the virtual social group, and the access allowance/rejection determination portion may determine whether or not to allow the first user to access the virtual social group by determining whether or not the user age of the first user corresponds to the restricted age for the social group evaluation rank of the virtual social group stored in the viewing restriction storage portion.

Further, the virtual social group management system may include a viewing restriction storage portion that stores, for each social group evaluation rank, a restricted age that is an age for which access to the content uploaded in the virtual social group is restricted. The user attribute storage portion may store, as the user attributes of the first user, a user age that is an age of the first user, the social group evaluation rank storage portion may store, as the social group evaluation rank for the virtual social group, a rank based on a user quality evaluation that is an evaluation of quality of a second user, from among the first users, who created the virtual social group, and the access allowance/rejection determination portion may determine whether or not to allow the first user to access the virtual social group by determining whether or not the user age of the first user corresponds to the restricted age for the social group evaluation rank of the virtual social group stored in the viewing restriction storage portion.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an example of a network system including an SNS system and terminal apparatuses.

FIG. 2 illustrates an example of the hardware configuration of an SNS system.

FIG. 3 illustrates an example of the functional configuration of an SNS system.

FIG. 4 illustrates an example of a posted content table.

FIG. 5 illustrates an example of community attribute data.

FIG. 6 illustrates an example of a community grade rank.

FIG. 7 illustrates an example of the flow of a member evaluation process.

FIG. 8 illustrates an example of moving posted article data of a specific user.

FIG. 9 illustrates an example of member evaluation data.

FIG. 10 illustrates an example of member attribute data.

FIG. 11 illustrates an example of graded access restriction data.

FIG. 12 illustrates an example of the flow of an access allowance/rejection determination process.

FIG. 13 illustrates an example of the flow of the overall processing performed by an SNS system.

### DESCRIPTION OF THE PREFERRED EMBODIMENTS

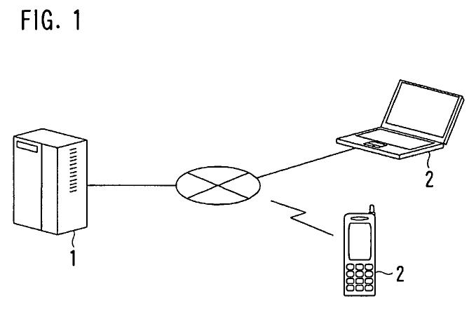

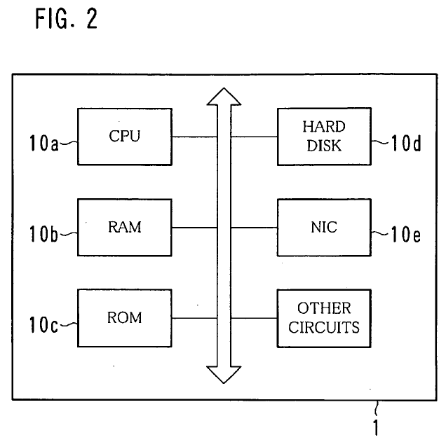

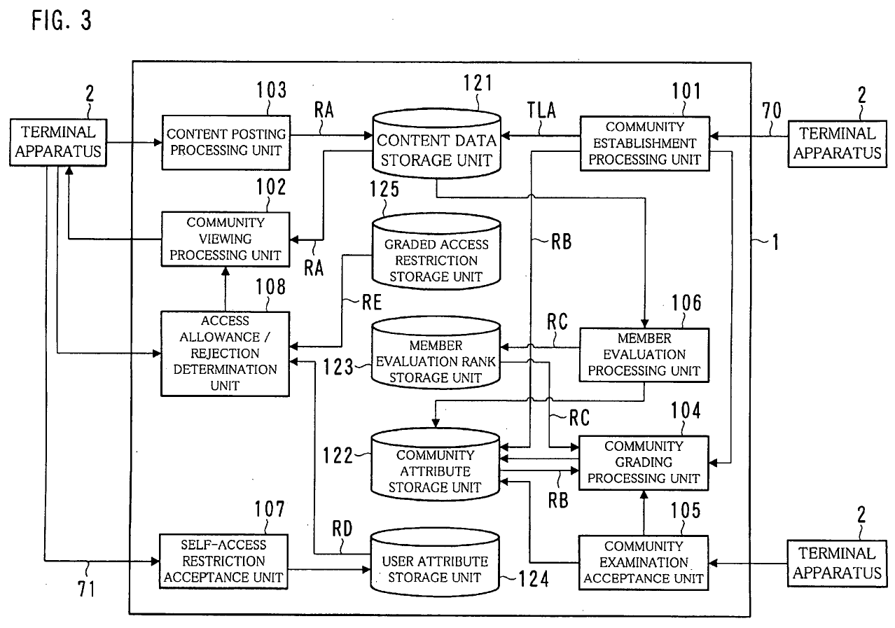

FIG. 1 illustrates an example of a network system including an SNS system 1 and terminal apparatuses 2; FIG. 2 illustrates an example of the hardware configuration of the SNS system 1; and FIG. 3 illustrates the functional configuration of the SNS system 1.

In FIG. 1, the SNS system 1 is a system by which a distributor provides SNS (Social Networking Service) services, such as, for example, messaging, diaries, communities, and friends to users who are members (referred to simply as “members” hereinafter).

The SNS system 1 differs from conventional systems particularly in that it restricts community access by its members. This restriction scheme shall be described in due order hereinafter.

As shown in FIG. 2, the SNS system 1 is configured of a CPU (Central Processing Unit) 10a, a RAM (Random Access Memory) 10b, a ROM (Read-Only Memory) 10c, a hard disk 10d, a NIC (Network Interface Card) 10e, and other various types of hardware.

Programs and data for implementing the functions of the following units, shown in FIG. 3, may be stored in the ROM 10c or the hard disk 10d. These units include a community establishment processing unit 101, a community viewing processing unit 102, a content posting processing unit 103, a community grading processing unit 104, a community examination acceptance unit 105, a member evaluation processing unit 106, a self-access restriction acceptance unit 107, an access allowance/rejection determination unit 108, a content data storage unit 121, a community attribute storage unit 122, a member evaluation rank storage unit 123, a user attribute storage unit 124, a graded access restriction storage unit 125, and so on. These programs and data are loaded into the RAM 10b and executed by the CPU 10a as necessary.

A workstation, a server device, or the like is used as the SNS system 1. The SNS system 1 can also be configured with the various units shown in FIG. 3 being spread out across multiple devices.

The terminal apparatus 2 is a client by which a member uses the SNS. The terminal apparatus 2 is provided with a function for connecting to the Internet, a web browser, and an email client. A personal computer, mobile telephone terminal, or the like can be used as the terminal apparatus 2. Each member may be given a single member ID (identification).

The SNS system 1 and each terminal apparatus 2 are capable of connecting to each other via a network such as the Internet.

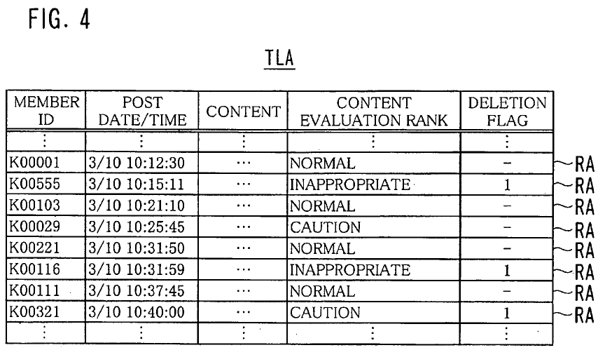

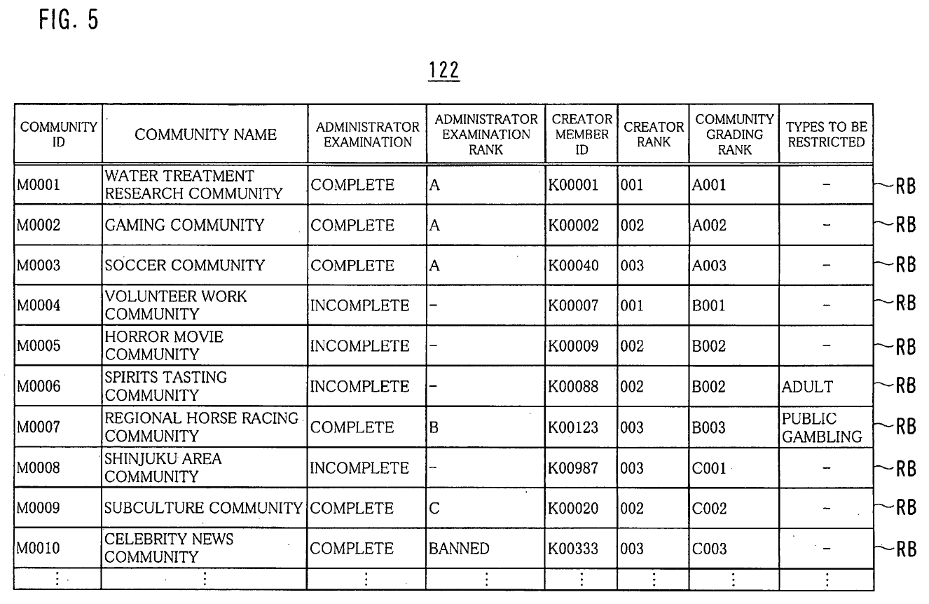

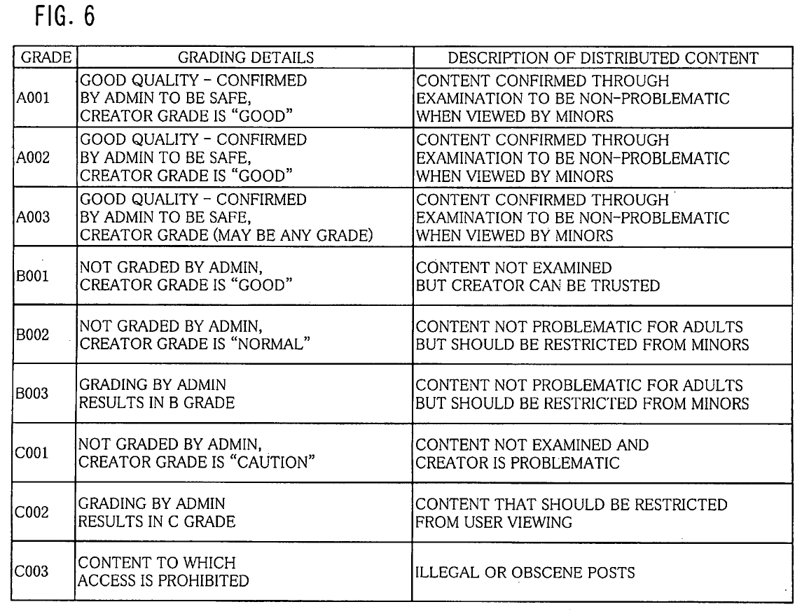

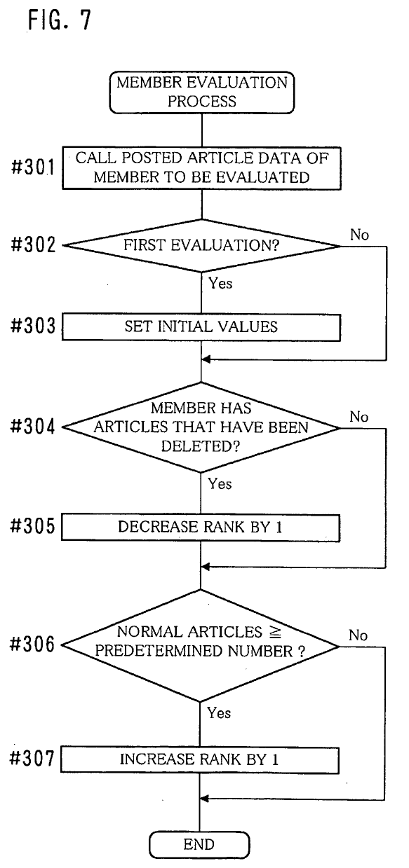

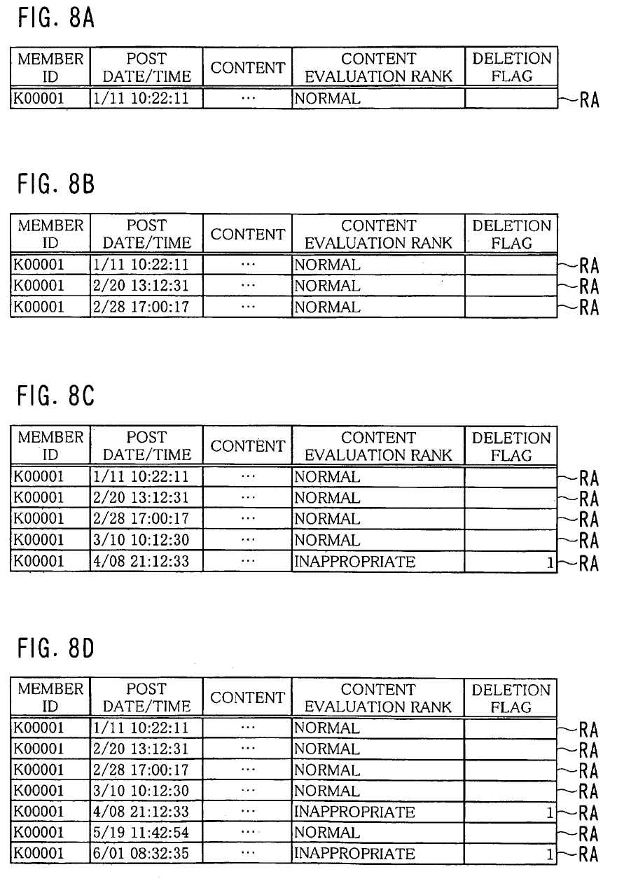

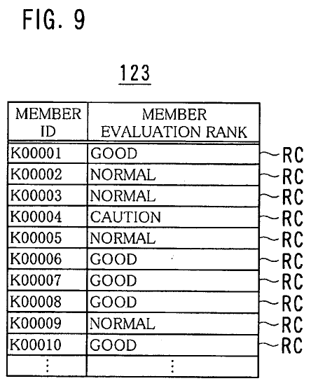

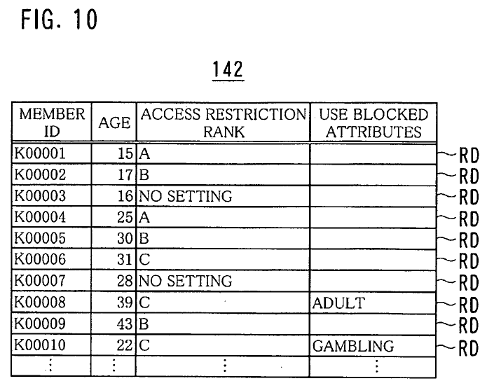

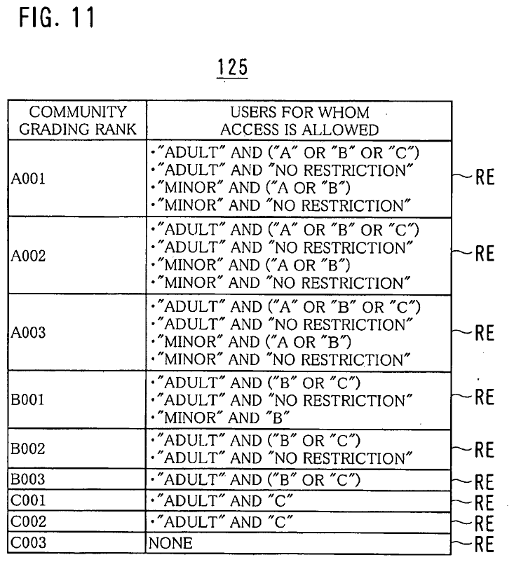

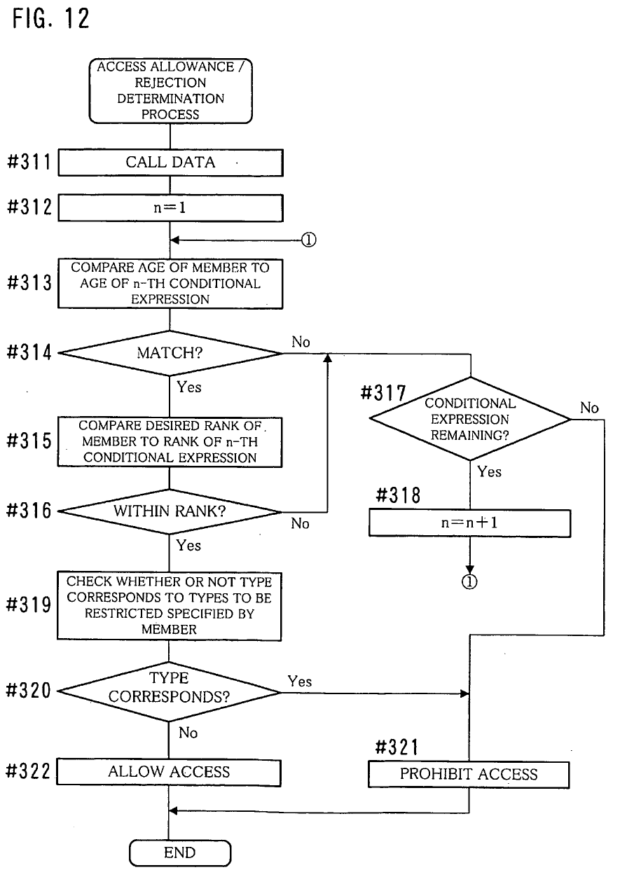

FIG. 4 illustrates an example of a posted content table TLA; FIG. 5 illustrates an example of community attribute data RB; FIG. 6 illustrates an example of a community grade rank; FIG. 7 is a flowchart illustrating an example of the flow of a member evaluation process; FIG. 8 illustrates an example of moving posted article data RA of a specific user; FIG. 9 illustrates an example of member evaluation data RC; FIG. 10 illustrates an example of member attribute data RD; FIG. 11 illustrates an example of graded access restriction data RE; and FIG. 12 illustrates an example of the flow of an access allowance/rejection determination process. Next, the functions of the various units of the SNS system 1 illustrated in FIG. 3 shall be described in detail.

The posted content table TLA is stored in the content data storage unit 121 on a community-by-community basis. As shown in FIG. 4, the posted content table TLA stores posted article data RA for each article posted (uploaded or written) to the community. The “member ID” in the posted article data RA is the member ID of the member who posted that article. “Post date/time” may be the date and time at which that article was posted. “Content” is text data indicating the details (content) of the article. “Content evaluation rank” indicates an evaluation of the quality of the content of the article (whether or not there are inappropriate points in the article). The evaluation method shall be described later.

“Deletion flag” is a flag that expresses whether or not the publication of the article is being stopped. The deletion flag being set (i.e., “1”) indicates that the publication of the article is being stopped, and thus the article is treated as if it has been deleted.

Note that a single community ID is provided for each community. The community ID of the community is associated with the posted content table TLA of that community.

The posted content table TLA is generated by the community establishment processing unit 101 each time a new community is established. Meanwhile, the posted article data RA is generated by the content posting processing unit 103 each time a new article is posted. This shall be described later in due order.

As shown in FIG. 5, community attribute data RB is stored, on a community-by-community basis, in the community attribute storage unit 122 shown in FIG. 3. In addition to the community ID of the community, information on the following attributes of the community is indicated in the community attribute data RB.

“Community name” is the name of the community. “Administrator examination” indicates whether or not the administrator of the SNS system 1 has examined the quality of the community.

“Administrator examination rank” is a rank expressing the results of the examination (evaluation) of the quality of the community by the administrator, or in other words, the degree of quality from the standpoint of the administrator. In the present embodiment, three ranks, or “A”, “B”, and “C”, are available.

“A” indicates good quality. To be more specific, “A” indicates that the content being distributed is not problematic at all, regardless of the age of the member who is viewing the content. “B”, meanwhile, indicates normal quality. To be more specific, “B” indicates that most of the content is not problematic, regardless of the age of the member who is viewing the content, but that inappropriate content appears from time to time. “C”, however, indicates that a high amount of inappropriate content is present, and that caution should be taken with regards to the publication of the community. Furthermore, in addition to these ranks, the administrator can provide an evaluation of “ban” in the case where s/he has determined during the examination that the publication of the community should be banned unconditionally. Hereinafter, the standards for these examinations shall be referred to as “content examination standards α”.

“Creator member ID” is the member ID of the member who established (created) the community. Hereinafter, the member who established the community may particularly be referred to as the “creator”. “Creator rank” is an evaluation rank for the creator him/herself. The evaluation is determined based on the quality of the articles posted by the creator to his/her own community or to communities of other members. In other words, the “creator rank” expresses the degree of quality of the creator's posts. In the present embodiment, three creator ranks, or “001”, “002”, and “003”, are available. “001” indicates good quality, while “002” indicates normal quality. “003” indicates that the creator is a person who is highly likely to make inappropriate posts and that caution should be taken with regards to him/her. The creator evaluation is carried out by the member evaluation processing unit 106, which shall be described later.

“Community grade rank” is a rank of the overall grade of the community. The grading process is carried out by the community grading processing unit 104. The grading may be, in principle, carried out based on both the results of the examination of the community by the administrator (the administrator examination rank) and the evaluation of the creator of that community (the creator rank). However, in the case where the administrator has not yet carried out the examination, the grading may be carried out based on the results of an examination carried out by the creator him/herself (a self-evaluation).

In the present embodiment, nine community grade ranks are available; these are, in order from the highest quality down, “A001”, “A002”, “A003”, “B001”, “B002”, “B003”, “C001”, “C002”, and “C003”. What each of these ranks indicates is shown in FIG. 6. The specific method for this grading shall be described later.

Incidentally, it is possible for communities that are undesirable to some members to exist. For example, communities having themes that focus on items restricted based on age, social standing, and so on, such as, for example, alcohol, cigarettes, mature movies, and public gambling, are undesirable for members to whom those restrictions apply. Hereinafter, types of themes that are undesirable to some members are referred to as “restricted types”. In the present embodiment, “adult”, to which belong themes aimed at adults (in other words, themes inappropriate for minors), “public gambling”, to which belong themes regarding horse racing, bicycle racing, and the like, and so on are available as types to be restricted.

Returning to the description of the community attribute data RB, the “restricted type” indicates the restricted type to which a theme belongs in the case where that community includes a theme that is undesirable for some members.

The community establishment processing unit 101 in FIG. 3 performs a process for establishing a new community in the SNS system 1 through, for example, the following procedure, in conjunction with the terminal apparatus 2.

A member first logs into the SNS system 1 using his/her own member ID by performing a predetermined operation through a terminal apparatus 2, and makes a request for the establishment of a community to the SNS system 1. At this time, the member may input the community name and his/her own self-evaluation. The “self-evaluation” is an evaluation regarding the quality of the community, made by the member (creator) him/herself. When a member creates a community, s/he anticipates what sort of content will be posted to that community, and examines the quality thereof in accordance with the abovementioned content examination standards α. The member then may decide on a rank of “A”, “B”, or “C”. Furthermore, in the case where that community includes a theme that is undesirable for some members, the member may input the restricted type to which that theme belongs.

The terminal apparatus 2 sends creator-inputted data 70, indicating the inputted content, to the SNS system 1.

The community establishment processing unit 101 issues a community ID to that community upon receiving the creator-inputted data 70. The community establishment processing unit 101 then generates an empty posted content table TLA (see FIG. 4), and stores that posted content table TLA in association with the issued community ID in the content data storage unit 121.

Furthermore, the community establishment processing unit 101 generates the community attribute data RB (see FIG. 5) for that community, and stores that data in the community attribute storage unit 122. Values such as those described hereinafter are stored in the various fields of the community attribute data RB.

The community ID currently issued for that community is indicated in the “community ID”. The name indicated in the creator-inputted data 70 received from the terminal apparatus 2 is indicated in the “community name”. “Incomplete”, indicating that the examination has not yet been carried out by the administrator, is indicated in the “administrator examination”. At this point in time, nothing may be indicated in the “administrator examination rank”. The member ID of the member who is the creator of the community is indicated in the “creator member ID”.

In the case where the creator has already been evaluated by the member evaluation processing unit 106, that evaluation (the same rank as the member evaluation rank in FIG. 9, discussed later) is indicated in the “creator rank”. However, in the case where the evaluation has not yet been carried out, nothing may be indicated here at this point in time.

In the case where a restricted type is indicated in the creator-inputted data 70, that restricted type is indicated in the “restricted type”.

The result of grading the community as performed by the community grading processing unit 104 is indicated in the “community grade rank”. As described above, in principle, the community grading processing unit 104 grades the community based on the results of the administrator examination (the administrator examination rank). However, at this point in time, the administrator may not be able to carry out the examination. Accordingly, the community grading processing unit 104 performs the grading as follows, based on the self-evaluation indicated in the creator-inputted data 70.

In the case where the self-evaluation rank indicated in the creator-inputted data 70 is “A”, the community grading processing unit 104 sets the community grade rank at “B001”. Meanwhile, in the case where the self-evaluation rank is “B”, the community grade rank is set at “B002”, and in the case where the self-evaluation rank is “C”, the community grade rank is set at “C001”.

Alternatively, in the case where the creator rank of that creator has already been determined by the member evaluation processing unit 106, the community grading processing unit 104 may carry out the grading in the following manner, based on that creator rank. In the case where the creator rank is “001”, the community grading processing unit 104 sets the community grade rank at “B001”. Meanwhile, in the case where the creator rank is “002”, the community grade rank is set at “B002”, and in the case where the creator rank is “003”, the community grade rank is set at “C001”.

The community viewing processing unit 102 shown in FIG. 3 performs processing for allowing members to view the content posted to a community in, for example, the following manner.

A member first logs into the SNS system 1 using his/her own member ID by performing a predetermined operation through a terminal apparatus 2, and specifies the community that s/he wishes to view.

The community viewing processing unit 102 then may display the top page screen of that community in the terminal apparatus 2, and allows the member to access that community. At this time, the community viewing processing unit 102 sends screen data for the display of that top page screen (an HTML file, a GIF file, or the like) to the terminal apparatus 2. Other screens described later are also displayed in the terminal apparatus 2 by sending screen data thereto.

The community name, a digest of new articles, a list of the articles that have been posted to the community, and so on are shown in the top page screen, based on the posted content table TLA (see FIG. 4) of that community. Furthermore, in the present embodiment, the result of the community grading (the community grade rank) is displayed as well.

When that member selects one of the articles, the community viewing processing unit 102 displays the content of the article stored in the posted content table TLA for that community in the terminal apparatus 2.

Accordingly, the processes following the operations performed by the member and the member accessing the community are basically the same as those performed conventionally, with the exception of the presentation of the grading result. However, in the present embodiment, a function for restricting access is executed prior to access. In other words, when a member attempts to access a community, the access allowance/rejection determination unit 108 determines whether or not it is acceptable to allow that member to access the community. The community viewing processing unit 102 allows the member to access that community only in the case where that access has been determined to be acceptable. The method by which the access allowance/rejection determination unit 108 performs this determination shall be described later.

After accessing the community, the member can not only view articles that already exist, but can post articles to that community, as is conventionally possible.

The content posting processing unit 103 performs processing for posting (uploading) an article to a community in, for example, the following manner. When a member inputs article content into the terminal apparatus 2, the content posting processing unit 103 receives the data of that content from the terminal apparatus 2.

The content posting processing unit 103 generates new posted article data RA for that article, and stores this generated data in the content data storage unit 121. Information such as that described hereinafter is indicated in the various fields of the posted article data RA. The member ID of the member who is the poster is indicated in “member ID”. The date and time at which the content of the article was received is indicated in “post date/time”. The content received is indicated in “content”.

An evaluation of the content of the article is shown in “content evaluation rank”. The content posting processing unit 103 evaluates the content of the article using, for example, the method described hereinafter.

Phrases that are prohibited from being written (hereinafter referred to as “prohibited phrases”) are pre-registered in a dictionary database. Thresholds Na and Nb are defined (where Na<Nb). When the number of prohibited phrases present in the content is greater than or equal to the threshold Nb, the content is evaluated as being inappropriate. When the number of prohibited phrases is greater than or equal to the threshold Na but lower than the threshold Nb, the content is evaluated as requiring caution with regards to publication. However, when the number of prohibited phrases is less than the threshold Na, the content is evaluated as being non-problematic (normal)

Alternatively, in the case where the member has posted no less than a predetermined number (for example, ten) of multiple articles with identical content or content having more than a predetermined amount of similarity across a predetermined short span of time (for example, five minutes), the content of those articles may be collectively evaluated as inappropriate. A method using a Levenshtein distance, such as that disclosed in Public Document 1 (JP 2007-310746A), can be given as an example of a method for calculating the similarity of content. Alternatively, the Iihashi method, as disclosed in Public Documents 2 (“Promoting ‘Similarities in Text and the Iihashi Method’, 16th University Education for the Next Generation ‘Cultivating Knowledge’ (Tokyo)—Sensitive Research Lifestyle (25)”, found through Internet search on Mar. 5, 2008, at http://shyosei.cocolog-nifty.com/shyoseilog/2007/08/1625_{—}2f2e.html) and 3 (“Second-type Character String Similarity Level Based On Appearance Frequency of Characters”, Iihashi, Yasuhiro, found through Internet search on Mar. 5, 2008, at http://www.sciencehouse.jp/etc/research/20070807.pdf), may be used.

Methods disclosed in other public documents may be used as well.

In the case where the content of the article has been determined to be inappropriate, “1” is shown in the “deletion flag”. In other cases, at this point in time, nothing is shown in the “deletion flag”.

Note that when the content of the article is evaluated as requiring caution with regards to publication, an administrator or the creator of the community is notified of that evaluation, as well as of the content of the article, using email or the like. The administrator or creator checks the notification, decides whether or not to delete the content, and responds via email or the like. In the case where the response indicates deletion, the deletion flag is set (i.e., updated to “1”) for that article.

The community examination acceptance unit 105 shown in FIG. 3 performs processing for accepting the result of the community examination performed by the administrator in, for example, the following manner.

The administrator examines a preexisting community as appropriate. The administrator does this periodically; for example, each week or each month. The administrator logs into the SNS system 1 using an administrator ID by performing a predetermined operation through a terminal apparatus 2, and specifies the community to be examined.

The community examination acceptance unit 105 displays the top page screen of that community in the terminal apparatus 2. Here, the administrator views the content of the articles posted to the community, in the same manner as a normal member. The administrator then examines the quality of the communities based on the abovementioned content examination standards α, and inputs the result of the examination (“A”, “B”, “C”, or “ban”).

The community examination acceptance unit 105 receives the inputted evaluation from the terminal apparatus 2 and writes that evaluation into “administrator examination rank” in the community attribute data RB of that community. In the case where an evaluation has already been written, the old evaluation is deleted, and the evaluation inputted at this time is written into the data. Furthermore, “complete”, indicating that the examination by the administrator has been completed, is written into “administrator examination”.

The member evaluation processing unit 106 performs a process for evaluating members. A member who has posted an article may be evaluated each time the article is posted or deleted, or multiple members may be collectively evaluated periodically (for example, each week, each day, or each month). Hereinafter, an evaluation method, which uses the evaluation of a member Kx as an example, shall be described with reference to FIG. 7.

The member evaluation processing unit 106 calls the posted article data RA for articles posted by the member Kx, or in other words, the posted article data RA that has the member ID of the member KX, from the posted content table TLA (see FIG. 4) (#301 in FIG. 7). Through this, the posted article data RA as shown in any one of FIGS. 8A to 8D is called, in accordance with the articles posted by the member Kx thus far.

In the case where this is the first opportunity for the member Kx to be evaluated (Yes in #302), the member evaluation processing unit 106 provides “002”, indicating “normal”, as an initial value (#303).

In the case where the member Kx posted an article after the previous process for evaluating that member Kx but the article was deleted, or in other words, there is posted article data RA in which the “deletion flag” is set to “1” for the article that was posted after the previous evaluation process (Yes in #304), the current evaluation rank is decreased by 1 (#305). Note that the current rank is also decreased by 1 in the case where the current evaluation process is the first evaluation process performed for the member Kx but there is posted article data RA where “1” is set for the “deletion flag”.

Alternatively, in the case where the member Kx posted no less than a predetermined number (for example, three) of articles evaluated as “normal” after having his/her evaluation altered, or in other words, there are no less than a predetermined number of pieces of posted article data RA in which the “content evaluation rank” is set to “normal” for the articles that were posted after the evaluation was altered (Yes in #306), the current evaluation rank is increased by 1 (#305). Note that the current evaluation rank is also increased by 1 in the case where the evaluation of the member Kx has not changed and the member Kx has posted no less than a predetermined number of articles with a “normal” evaluation after the member Kx has been evaluated for the first time.

For example, in the case where the member Kx is to be evaluated by the member evaluation processing unit 106 for the first time after the member Kx has made his/her first post, a single piece of posted article data RA, as shown in FIG. 8A, is called. The member evaluation processing unit 106 sets the evaluation rank of the member Kx to “002”, as per the procedure illustrated in FIG. 7. According to the posted article data RA in FIG. 8A, the rank of the member Kx is to be neither increased nor decreased. Accordingly, this evaluation of the member Kx results in “002”.

Furthermore, after this, the member evaluation processing unit 106 calls posted article data RA such as that shown in FIG. 8B in order to evaluate the member Kx once again. In this posted article data RA, it can be seen that the evaluation of the member Kx has not changed between the member Kx being evaluated for the first time and the present time, and that the member Kx has posted no less than a predetermined number (three) of articles with a “normal” evaluation. Therefore, the member evaluation processing unit 106 increases the current evaluation rank of the member Kx by 1, reevaluating the member Kx as “001”, indicating “good quality”.

Furthermore, after this, the member evaluation processing unit 106 calls posted article data RA such as that shown in FIG. 8C in order to evaluate the member Kx once again. In this posted article data RA, it can be seen that an article posted by the member Kx has been deleted after the previous evaluation. Therefore, the member evaluation processing unit 106 decreases the current evaluation rank of the member Kx by 1, reevaluating the member Kx as “002”.

Furthermore, after this, the member evaluation processing unit 106 calls posted article data RA such as that shown in FIG. 8D in order to evaluate the member Kx once again. In this posted article data RA, it can be seen that an article posted by the member Kx has been deleted following the previous evaluation. Therefore, the member evaluation processing unit 106 decreases the current evaluation rank of the member Kx by 1, reevaluating the member Kx as “003”, indicating that caution is required.

The member evaluation data RC, shown in FIG. 9, is stored in the member evaluation rank storage unit 123 shown in FIG. 3, and indicates, on a member-by-member basis, the result of the latest evaluation performed by the member evaluation processing unit 106 (the member evaluation rank).

Meanwhile, in the case where a community whose creator is the member who has been evaluated is present, the “creator rank” in the community attribute data RB of that community is updated to reflect the result of the evaluation.

The community grading processing unit 104 performs the process for grading the community based on the self-evaluation of the creator of the community, as described earlier; however, after examination by the administrator, the community grading processing unit 104 operates based on the results of that examination, in the following manner.

The community grading processing unit 104 calls, from the community attribute storage unit 122, the community attribute data RB of the community being examined for the first time or being examined again by the administrator, or in other words, the community attribute data RB in which the “administrator examination rank” has been updated.

Then, the community grading processing unit 104 sets the grading rank (community grade rank) by combining the administrator examination rank and the creator rank in the community attribute data RB.

In other words, in the case where the administrator examination rank is “X” (where “X” is one of “A”, “B”, and “C”) and the creator rank is “yyy” (where “yyy” is one of “001”, “002”, and “003”), a rank of “Xyyy” is set.

However, in the case where the administrator examination rank is “ban”, the rank is set to “C003”, regardless of the creator rank.

The grading process is performed in this manner. The result of the grading is written into “community grade rank” in the community attribute data RB of that community.

Member attribute data RD, as shown in FIG. 10, is stored on a member-by-member basis in the user attribute storage unit 124 shown in FIG. 3. In addition to the member ID of each member, the member attribute data RD includes the following information.

“Age” is the age of the member. “Access restriction rank” indicates the minimum quality level (community grade rank) of the communities that member wishes to view. “Types to be restricted” indicates the restricted types of communities, which the member does not wish to view. The “access restriction rank” and “types to be restricted” can be set by the member him/herself. In other words, the member can restrict access to the community by him/herself.

The member attribute data RD is generated or updated by the self-access restriction acceptance unit 107 in the following manner.

When a new member has joined the SNS, a member ID is issued to that member, as is conventionally done.

Upon doing so, the self-access restriction acceptance unit 107 generates the member attribute data RD indicating the member ID and age of that member, and stores that data in the user attribute storage unit 124. The age can be found by referring to the profile inputted by the member upon joining the SNS. At this point in time, nothing is stored in “access restriction rank” and “types to be restricted”.

A member that wishes to restrict his/her own access first logs into the SNS system 1 using his/her member ID by performing a predetermined operation through a terminal apparatus 2, and then makes settings with respect to the SNS system 1 for restricting access. At this time, that member inputs at least one of the following: the minimum rank (community grade rank) of communities that the member wishes to view; and the restricted types of communities, which the member does not wish to view. However, members who are minors cannot specify “C” as the minimum rank of communities that they wish to view.

The terminal apparatus 2 sends self-access restriction data 71, indicating the inputted details, to the SNS system 1.

Upon receiving the self-access restriction data 71, the self-access restriction acceptance unit 107 retrieves the member attribute data RD of that member ID from the user attribute storage unit 124. Then, the self-access restriction acceptance unit 107 writes the community grade rank and restricted type indicated in the self-access restriction data 71 into the “access restriction rank” and “types to be restricted” in the member attribute data RD.

Graded access restriction data RE is stored in the graded access restriction storage unit 125 for each community grade rank, as shown in FIG. 11. The graded access restriction data RE indicates conditional expressions that express the conditions under which a member is authorized to access communities that have been given that community grade rank. The meanings of the conditional expressions shall be described next along with the access allowance/rejection determination unit 108.

When a member attempts to view a community, the access allowance/rejection determination unit 108 determines whether or not that member can access that community. The process for this determination is performed through the procedure shown in FIG. 12. The procedure of the determination process shall be explained hereinafter, using a case where a member Ka is attempting to view a community Mb as an example.

The member Ka logs into the SNS system 1 using his/her member ID, and specifies the community Mb as the community s/he wishes to view. Upon doing so, prior to the process for viewing the community Mb being commenced by the community viewing processing unit 102, the access allowance/rejection determination unit 108 determines whether or not the member Ka should be allowed to access the community Mb in the following manner.

The access allowance/rejection determination unit 108 calls the member attribute data RD for the member Ka, the community attribute data RB for the community Mb, and the graded access restriction data RE of the community grade rank for the community Mb from their respective storage units (#311 in FIG. 12).

One or more conditional expressions are present in the called graded access restriction data RE. If the attributes of the community Mb and the member Ka indicated in the called community attribute data RB and the called member attribute data RD, respectively, fulfill any one of the conditional expressions, the access allowance/rejection determination unit 108 determines that it is acceptable to allow access. However, if none of the conditional expressions are fulfilled, the access allowance/rejection determination unit 108 determines that access is to be prohibited.

In other words, the access allowance/rejection determination unit 108 first focuses on the first conditional expression (#312). The age indicated in the member attribute data RD, or in other words, the age of the member Ka, is compared to the age or age group indicated in the conditional expression (hereinafter referred to as “A1”) (#313). Furthermore, the access restriction rank indicated in the member attribute data RD, or in other words, the minimum community grade rank of communities that the member Ka wishes to view, is compared to the community grade rank indicated in that conditional expression (hereinafter referred to as “R1”) (#315). If, in Step #313, the age of the member Ka corresponds to A1 (Yes in #314), and, in Step #315, the minimum community grade rank of communities corresponds to any of items indicated in R1 or R1 is defined as “no access restriction” (Yes in #316), that conditional expression can be determined to be fulfilled.

If, in Step #313, the age of the member Ka does not correspond to A1 (No in #314), or, in Step #315, the minimum community grade rank of communities does not correspond to any items indicated in R1 (No in #316), and conditional expressions that have not yet been focused on remain in the graded access restriction data RE (Yes in #317), one of the conditional expressions that has not yet been focused on is focused on (Yes in #318), and the comparison processing performed in Steps #313 through #316 is performed in the same manner as with the first conditional expression.

Once it has been determined through the abovementioned comparison processing that one of the conditional expressions is fulfilled, the access allowance/rejection determination unit 108 compares the types to be restricted indicated in the member attribute data RD, or in other words, the types to be restricted with respect to communities that the member Ka does not wish to view, with the types to be restricted indicated in the community attribute data RB (#319).

Then, in the case where any one of the former corresponds to any one of the latter (Yes in #320), the member Ka is prohibited from accessing the community Mb (#321). In the case where none of the former correspond to any of the latter (No in #320), the member Ka is allowed to access the community Mb (#322).

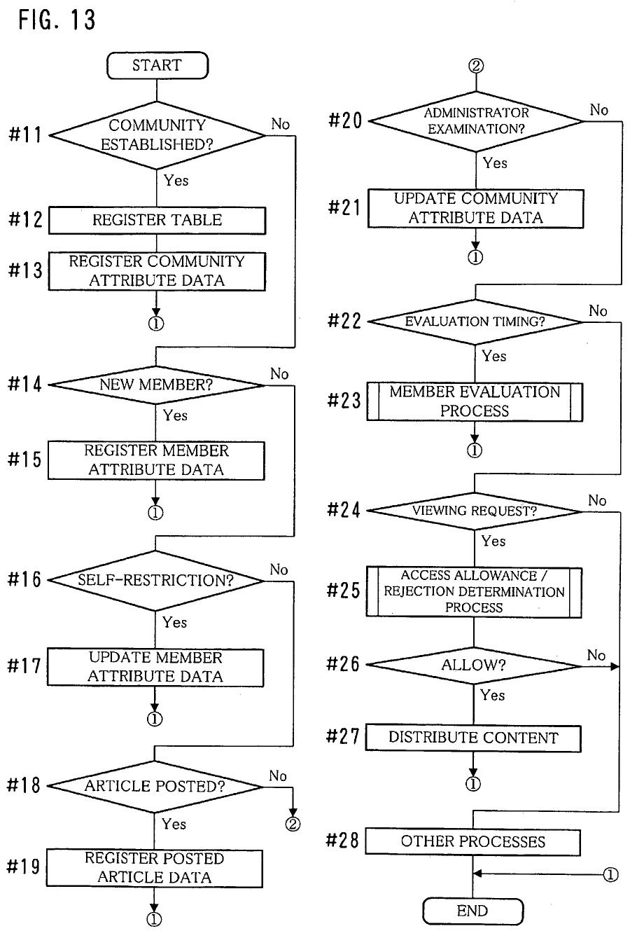

FIG. 13 is a flowchart illustrating an example of the flow of the overall processing performed by the SNS system 1.

Next, the flow of the overall processing performed by the SNS system 1 when a community service is provided to a member shall be described with reference to the flowchart in FIG. 13.

Each time the SNS system 1 receives data from the terminal apparatus 2 of a member or an administrator, or at a predetermined timing, the SNS system 1 executes a process as follows, in accordance with that data or timing.

Upon receiving a request for the establishment (creation) of a new community and creator-inputted data 70 from the terminal apparatus 2 of a member (Yes in #11), the SNS system 1 performs processes for the establishment of that community, such as generating and storing a posted content table TLA (see FIG. 4) for that community (#12), generating and storing community attribute data RB (see FIG. 5) for that community (#13), and so on.

Moreover, upon receiving an application for membership from a terminal apparatus 2 (Yes in #14), the SNS system 1 performs processes for membership, such as generating and storing member attribute data RD for the member who is to be granted membership (#15).

Moreover, upon receiving data for restricting the member's own access to a community (the self-access restriction data 71) from the terminal apparatus 2 of the member (Yes in #16), the SNS system 1 updates the member attribute data RD of the member to reflect the details of the restriction indicated in the self-access restriction data 71 (#17).

Moreover, upon receiving content of an article to be posted from the terminal apparatus 2 of the member (Yes in #18), the SNS system 1 generates posted article data RA for that article and adds the generated data to the posted content table TLA of the community to which the article is to be posted (#19). The content of the article is uploaded to the community thereby.

Moreover, upon receiving the result of a community examination performed by an administrator (a community grade rank) from the terminal apparatus 2 of the administrator (Yes in #20), the SNS system 1 reflects that community grade rank in the community attribute data RB for that community (#21).

Moreover, when the timing at which a member is to be evaluated is reached (Yes in #22), the SNS system 1 executes the process for evaluating that member using the procedure described earlier using FIG. 7 (#23).

Moreover, upon receiving a request to view a community from the terminal apparatus 2 of a member (Yes in #24), the SNS system 1 determines whether or not it is acceptable for the member to access that community using the procedure described earlier using FIG. 12 (#25). The content and the like of that community is distributed to the member (#27) only in the case where that access has been determined to be acceptable.

The SNS system 1 also performs processing for providing services such as messaging, diaries, friends, and so on to the member in accordance with other types of data received from the terminal apparatus 2.

According to the present embodiment, a member can view articles posted to communities in a more appropriate manner than was conventionally possible.

Although the present embodiment describes an example in which the access to an SNS community is restricted, the present invention can be applied to the restriction of access to other services, such as diaries, as well. Furthermore, the present invention can be applied to content distribution media for services in forms different from SNSs, such as electronic bulletin boards operated by electronic communications services, ISPs (Internet Service Providers), and so on.

Although members select the minimum rank of communities they wish to browse from a three-step ranking, or “A”, “B”, and “C”, in the present embodiment, the selection may be made from a nine-step ranking, as shown in FIG. 6. In this case, the conditional expressions in the graded access restriction data RE also use the nine-step ranking shown in FIG. 6.

Furthermore, other conditions aside from age group (in the present embodiment, whether the member is an adult or a minor) may be enabled to be set in the conditional expressions' of the graded access restriction data RE. For example, attributes such as the member's sex, social status (whether or not the member is a student), and so on may be enabled to be set as conditions.

The content evaluation rank, administrator examination rank, self-evaluation rank, and creator rank do not necessarily have to be three-step rankings. The rankings may have four steps, or may have two steps. Similarly, the community grade rank may have ten or more steps, or may have eight or fewer steps.

Although in the present embodiment, the member evaluation is carried out based on whether or not an article posted by the member was deleted and whether or not the member has posted non-problematic (normal) articles no less than a predetermined number of times, this evaluation may be carried out based on other items as well. For example, corrections may be made so that the creator rank is increased in the case where patterns that indicate quality usage are seen, such as when a member posts a predetermined number of articles within a predetermined period (for example, between five and thirty posts in one week).

In addition, many modifications to part or all of the configuration of the SNS system 1, the processing details, the processing order, the data structure, and so on can be made without deviating from the scope of the present invention.

Moreover, according to an aspect of the present invention, the system disclosed in the present application includes: a user attribute storage portion that stores, for each first user, user attributes that are attributes of the first user, a social group evaluation rank storage portion that stores a social group evaluation rank for each virtual social group by which the first users exchange content with one another via a communication line, the social group evaluation rank being a rank of evaluation of the virtual social group, an access allowance/rejection determination portion that determines whether or not to allow the first user to access the virtual social group based on the social group evaluation rank for the virtual social group stored in the social group evaluation rank storage portion and the user attributes of the first user stored in the user attribute storage portion, and a content distribution portion that executes a process for distributing content uploaded in the virtual social group to the first user where the access allowance/rejection determination portion has determined to allow the first user to access the virtual social group, and does not execute the process for distributing the content uploaded in the virtual social group to the first user where the access allowance/rejection determination portion has determined to prohibit the first user from accessing the virtual social group. According to such a configuration, the determination of whether or not to allow access is made by matching the social group evaluation rank with user attributes, making it possible to determine whether or not to allow access based on the characteristics of users, and thus controlling the access of content with certainty.

Moreover, according to an aspect of the present invention, the system disclosed in the present application includes: a viewing restriction storage portion that stores, for each social group evaluation rank, a restricted age that is an age for which access to the content uploaded in the virtual social group is restricted, wherein the user attribute storage portion stores, as the user attributes of the first user, a user age that is an age of the first user, the social group evaluation rank storage portion stores, as the social group evaluation rank for the virtual social group, a rank based on a content quality evaluation that is an evaluation of quality of the content uploaded in the virtual social group, and the access allowance/rejection determination portion determines whether or not to allow the first user to access the virtual social group by determining whether or not the user age of the first user corresponds to the restricted age for the social group evaluation rank of the virtual social group stored in the viewing restriction storage portion. According to such a configuration, the determination of whether or not to allow access is made based on the age group of the user, making it possible to appropriately restrict access to content for which viewing restrictions are demanded based on age, such as content with sexual themes, violence, and so on. As a result, users can view the content of a virtual social group, such as an electronic bulletin board or a community, in a more appropriate manner than was conventionally possible.

Moreover, according to an aspect of the present invention, the system disclosed in the present application includes: an evaluation result receiving portion that receives a result of an evaluation of the content uploaded in the virtual social group, performed by an administrator, as the content quality evaluation, wherein the social group evaluation rank storage portion stores, as the social group evaluation rank for the virtual social group, a rank based on the content quality evaluation of the content uploaded in the virtual social group received by the evaluation result receiving portion. According to such a configuration, the determination of whether or not to allow access is made based on the result of an objective evaluation of the content by a third party, making it possible to evaluate the content in a more trustworthy manner than when the creator of the content evaluates the content him/herself. As a result, users can view the content of a virtual social group, such as an electronic bulletin board or a community, in a more appropriate manner than was conventionally possible.

According to an aspect of the present invention, the system disclosed in the present application includes: a viewing restriction storage portion that stores, for each social group evaluation rank, a restricted age that is an age for which access to the content uploaded in the virtual social group is restricted, wherein the user attribute storage portion stores, as the user attributes of the first user, a user age that is an age of the first user, the social group evaluation rank storage portion stores, as the social group evaluation rank for the virtual social group, a rank based on a user quality evaluation that is an evaluation of quality of a second user, from among the first users, who created the virtual social group, and the access allowance/rejection determination portion determines whether or not to allow the first user to access the virtual social group by determining whether or not the user age of the first user corresponds to the restricted age for the social group evaluation rank of the virtual social group stored in the viewing restriction storage portion. According to such a configuration, an age group that is allowed access is set for each social group, making it possible to set whether or not access is allowed with less trouble than when making the settings per content, and making it possible to collectively restrict content whose creator has been evaluated poorly. As a result, users can view the content of a virtual social group, such as an electronic bulletin board or a community, in a more appropriate manner than was conventionally possible.

According to an aspect of the present invention, the system disclosed in the present application includes: a user evaluation portion that determines the user quality evaluation of a third user, from among the first users, who uploaded content to the virtual social group by checking whether or not a predetermined phrase is present in the content uploaded in the virtual social group, wherein the social group evaluation rank storage portion stores, as the social group evaluation rank for the virtual social group, a rank based on the user quality evaluation, determined by the user evaluation portion, of the second user. According to such a configuration, the quality of users is evaluated automatically based on the content the users uploaded, making it possible to effectively control the registration of content that includes prohibited phrases. As a result, users can view the content of a virtual social group, such as an electronic bulletin board or a community, in a more appropriate manner than was conventionally possible.

According to an aspect of the present invention, the system disclosed in the present application includes: a user evaluation portion that determines the user quality evaluation of the first user based on a pattern according to which the first user uploads the content to the virtual social group, wherein the social group evaluation rank storage portion stores, as the social group evaluation rank for the virtual social group, a rank based on the user quality evaluation, determined by the user evaluation portion, of the second user. According to such a configuration, the quality of users is evaluated automatically based on the upload patterns of the users, making it possible to effectively control the writing of content in wrongful upload patterns. As a result, users can view the content of a virtual social group, such as an electronic bulletin board or a community, in a more appropriate manner than was conventionally possible.

According to an aspect of the present invention, the system disclosed in the present application includes: a viewing restriction storage portion that stores, for each social group evaluation rank, a restricted age that is an age for which access to the content uploaded in the virtual social group is restricted, wherein the user attribute storage portion stores, as the user attributes of the first user, a user age that is an age of the first user, the social group evaluation rank storage portion stores, as the social group evaluation rank for the virtual social group, a comprehensive evaluation rank of quality of the content uploaded in the social group and quality of a second user, from among the first users, who created the virtual social group, and the access allowance/rejection determination portion determines whether or not to allow the first user to access the virtual social group by determining whether or not the user age of the first user corresponds to the restricted age for the social group evaluation rank of the virtual social group stored in the viewing restriction storage portion. According to such a configuration, the quality of the content uploaded to the social group and the quality of the user that created the social group are comprehensively evaluated, making it possible to perform evaluation more accurately than when basing the evaluation on a single factor. As a result, users can view the content of a virtual social group, such as an electronic bulletin board or a community, in a more appropriate manner than was conventionally possible.

According to an aspect of the present invention, the system disclosed in the present application includes: a social group type storage portion that stores, for each virtual social group, a type of a theme of the virtual social group, and a self-restriction type storage portion that stores, for each first user, a type of a virtual social group that the first user does not wish to access, wherein the access allowance/rejection determination portion determines to prohibit the first user from accessing the virtual social group where any of the types of the virtual social group that the first user does not wish to access stored in the self-restriction type storage portion correspond to any of the types of the theme of the virtual social group stored in the social group type storage portion, regardless of whether or not the user age of the first user corresponds to the restricted age for the social group evaluation rank of the virtual social group. According to such a configuration, the determination of whether or not to allow access is made by matching the theme of the social group with a self-restriction type storage portion, making it possible to automatically restrict access to social communities that do not match the preferences of the user. As a result, users can view the content of a virtual social group, such as an electronic bulletin board or a community, in a more appropriate manner than was conventionally possible.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A virtual social group management system comprising:
a user attribute storage portion that stores, for each first user, user attributes that are attributes of the first user;
a social group evaluation rank storage portion that stores a social group evaluation rank for each virtual social group by which the first users exchange content with one another via a communication line, the social group evaluation rank being a rank of evaluation of the virtual social group;
an access allowance/rejection determination portion that determines whether or not to allow the first user to access the virtual social group based on the social group evaluation rank for the virtual social group stored in the social group evaluation rank storage portion and the user attributes of the first user stored in the user attribute storage portion; and
a content distribution portion that executes a process for distributing content uploaded in the virtual social group to the first user where the access allowance/rejection determination portion has determined to allow the first user to access the virtual social group, and does not execute the process for distributing the content uploaded in the virtual social group to the first user where the access allowance/rejection determination portion has determined to prohibit the first user from accessing the virtual social group.

2. The virtual social group management system according to claim 1, further comprising:
a viewing restriction storage portion that stores, for each social group evaluation rank, a restricted age that is an age for which access to the content uploaded in the virtual social group is restricted,
wherein the user attribute storage portion stores, as the user attributes of the first user, a user age that is an age of the first user;
the social group evaluation rank storage portion stores, as the social group evaluation rank for the virtual social group, a rank based on a content quality evaluation that is an evaluation of quality of the content uploaded in the virtual social group; and
the access allowance/rejection determination portion determines whether or not to allow the first user to access the virtual social group by determining whether or not the user age of the first user corresponds to the restricted age for the social group evaluation rank of the virtual social group stored in the viewing restriction storage portion.

3. The virtual social group management system according to claim 2, further comprising:
an evaluation result receiving portion that receives a result of an evaluation of the content uploaded in the virtual social group, performed by an administrator, as the content quality evaluation,
wherein the social group evaluation rank storage portion stores, as the social group evaluation rank for the virtual social group, a rank based on the content quality evaluation of the content uploaded in the virtual social group received by the evaluation result receiving portion.

4. The virtual social group management system according to claim 1, further comprising:
a viewing restriction storage portion that stores, for each social group evaluation rank, a restricted age that is an age for which access to the content uploaded in the virtual social group is restricted,
wherein the user attribute storage portion stores, as the user attributes of the first user, a user age that is an age of the first user;
the social group evaluation rank storage portion stores, as the social group evaluation rank for the virtual social group, a rank based on a user quality evaluation that is an evaluation of quality of a second user, from among the first users, who created the virtual social group; and
the access allowance/rejection determination portion determines whether or not to allow the first user to access the virtual social group by determining whether or not the user age of the first user corresponds to the restricted age for the social group evaluation rank of the virtual social group stored in the viewing restriction storage portion.

5. The virtual social group management system according to claim 4, further comprising:
a user evaluation portion that determines the user quality evaluation of a third user, from among the first users, who uploaded content to the virtual social group by checking whether or not a predetermined phrase is present in the content uploaded in the virtual social group,
wherein the social group evaluation rank storage portion stores, as the social group evaluation rank for the virtual social group, a rank based on the user quality evaluation, determined by the user evaluation portion, of the second user.

6. The virtual social group management system according to claim 5, further comprising:
a user evaluation portion that determines the user quality evaluation of the first user based on a pattern according to which the first user uploads the content to the virtual social group,
wherein the social group evaluation rank storage portion stores, as the social group evaluation rank for the virtual social group, a rank based on the user quality evaluation, determined by the user evaluation portion, of the second user.

7. The virtual social group management system according to claim 1, further comprising:
a viewing restriction storage portion that stores, for each social group evaluation rank, a restricted age that is an age for which access to the content uploaded in the virtual social group is restricted,
wherein the user attribute storage portion stores, as the user attributes of the first user, a user age that is an age of the first user;
the social group evaluation rank storage portion stores, as the social group evaluation rank for the virtual social group, a comprehensive evaluation rank of quality of the content uploaded in the social group and quality of a second user, from among the first users, who created the virtual social group; and
the access allowance/rejection determination portion determines whether or not to allow the first user to access the virtual social group by determining whether or not the user age of the first user corresponds to the restricted age for the social group evaluation rank of the virtual social group stored in the viewing restriction storage portion.

8. The virtual social group management system according to claim 2, further comprising:
a social group type storage portion that stores, for each virtual social group, a type of a theme of the virtual social group; and
a self-restriction type storage portion that stores, for each first user, a type of a virtual social group that the first user does not wish to access,
wherein the access allowance/rejection determination portion determines to prohibit the first user from accessing the virtual social group where any of the types of the virtual social group that the first user does not wish to access stored in the self-restriction type storage portion correspond to any of the types of the theme of the virtual social group stored in the social group type storage portion, regardless of whether or not the user age of the first user corresponds to the restricted age for the social group evaluation rank of the virtual social group.

9. A virtual social group management method, comprising:
storing, in advance, for each user, user attributes that are attributes of the user in a user attribute storage portion;
storing, in advance, a social group evaluation rank in a social group evaluation rank storage portion for each virtual social group by which the users exchange content with one another via a communication line, the social group evaluation rank being a rank of evaluation of the virtual social group; and
causing a computer to:
execute a process for determining whether or not to allow the user to access the virtual social group based on the social group evaluation rank for the virtual social group stored in the social group evaluation rank storage portion and the user attributes of the user stored in the user attribute storage portion; and
execute a process for distributing content uploaded in the virtual social group to the user where it has been determined to allow the user to access the virtual social group, and not execute the process for distributing the content uploaded in the virtual social group to the user where it has been determined to prohibit the user from accessing the virtual social group.

10. A computer-readable recording medium storing a computer program for controlling a computer that manages a virtual social group for users to exchange content with one another via a communication line, the computer program causing a computer to:
execute a process for storing, for each user, user attributes that are attributes of the user in a user attribute storage portion;
execute a process for storing, for each virtual social group, a social group evaluation rank in a social group evaluation rank storage portion the social group evaluation rank being a rank of evaluation of the virtual social group;
execute a process for determining whether or not to allow the user to access the virtual social group based on the social group evaluation rank for the virtual social group stored in the social group evaluation rank storage portion and the user attributes of the user stored in the user attribute storage portion; and
execute a process for distributing content uploaded in the virtual social group to the user where it has been determined to allow the user to access the virtual social group, and not execute the process for distributing the content uploaded in the virtual social group to the user where it has been determined to prohibit the user from accessing the virtual social group.
